(19) United States
(12) Patent Application Publication
(10) Pub. No.: US 2015/0026033 A1
(43) Pub. Date: Jan. 22, 2015

(54) EFFICIENT SELF-MATCH PREVENTION IN AN ELECTRONIC MATCH ENGINE

(71) Applicant: Chicago Mercantile Exchange Inc., Chicago, IL (US)

(72) Inventors: John Curran, Chicago, IL (US); Akira Yamaguchi, Chicago, IL (US); Brian Wolf, Chicago, IL (US); Pearce Peck-Walden, Chicago, IL (US); James Wilcox, Chicago, IL (US); James Bailey, Chicago, IL (US); Neil Lustyk, Chicago, IL (US); Katherine Patrick, Chicago, IL (US); Paul A. Bauerschmidt, Chicago, IL (US); Ari L. Studnitzer, Chicago, IL (US); William J. Albert, Chicago, IL (US); Paul J. Callaway, Chicago, IL (US); James W. Farrell, Chicago, IL (US); A. Shanthi Thiruthuvadoss, Chicago, IL (US)

(73) Assignee: Chicago Mercantile Exchange Inc.

(21) Appl. No.: 14/506,196

(22) Filed: Oct. 3, 2014

Related U.S. Application Data
(63) Continuation-in-part of application No. 11/601,489, filed on Nov. 17, 2006.
(60) Provisional application No. 60/738,246, filed on Nov. 18, 2005.

(51) Int. Cl. G06Q 40/04; G06F 17/30

(52) U.S. Cl. CPC G06Q 40/04; G06F 17/30495
USPC 705/37

(57) ABSTRACT

Protections against self-matching trade orders are disclosed which maximize liquidity/efficiency by reducing/minimizing unnecessary cancelations and/or resubmissions. Rather than automatically cancel or modify the incoming and/or self-matching counter orders, those resting counter orders, which would result in the occurrence of a self-match with an incoming order, are placed in a hold state or otherwise set aside such that the incoming order may be matched with other non-self-matching orders. The held orders are subsequently returned to the order book at the same, or different, priority to await a subsequent incoming order. Where the incoming order is not fully satisfied, only self-matching counter orders are identified or the return of held orders would result in a crossed order book, a trader may include instructions with the incoming order directing the system to cancel the self-matching resting orders, cancel the incoming order, decrementing the quantity of the larger of the incoming and self-matching resting orders by the quantity of the smaller thereof, or take some other action.

### REFERENCE TO RELATED APPLICATIONS

This application is a continuation-in-part under 37 C.F.R. §1.53(b) of U.S. patent application Ser. No. 11/601,489 filed Nov. 17, 2006, now U.S. Pat. No. ______, which claims the benefit of the filing date under 35 U.S.C. §119(e) of U.S. Provisional Application Ser. No. 60/738,246 filed Nov. 18, 2005, all of which are hereby incorporated by reference.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract, price.

Typically, the Exchange provides for a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Generally, matching is the process by which, for an incoming order to trade, e.g. to buy or sell a quantity of a financial instrument at a particular price, the trading system attempts to identify a previously received but unsatisfied order, referred to as a “resting order”, counter thereto. Previously received, but unsatisfied orders, are maintained by the trading system in an “order book”, e.g. a database maintaining data records of the previously received orders, data representative of when those orders were received and data representative of the market participants who submitted the orders. If a previously received counter order cannot be identified for a given incoming order or those previously received counter orders which are identified are not for a quantity sufficient to satisfy the incoming order's quantity, data representative of the incoming order, or residual unsatisfied quantity thereof, may be placed, i.e. “rested,” in the order book database to await a subsequently received incoming order, an instruction to modify or cancel the order from the originating market participant, or, in the case of special order types which provide for automated processing, an event or circumstance triggering such automated action. If more than one previously received but unsatisfied order is identified as being counter to the incoming order but the total quantity desired by the identified counter orders exceeds the quantity of the incoming order, the trading system may implement an order quantity allocation algorithm to distribute the available incoming quantity across one or more of the identified counter orders. Such algorithms include, but are not limited to, first-in-first-out (“FIFO”) (also referred to as price-time priority), which allocates the incoming quantity to the earlier received orders until exhausted, and pro-rata, which proportionally allocates the incoming quantity across all, or a select subset, of the identified counter orders. Other algorithms include Price Explicit Time, Order Level Pro Rata, Order Level Priority Pro Rata, Preference Price Explicit Time, Preference Order Level Pro Rata, Preference Order Level Priority Pro Rata, Threshold Pro-Rata, Priority Threshold Pro-Rata, Preference Threshold Pro-Rata, Priority Preference Threshold Pro-Rata, Split Price-Time Pro-Rata. A particular allocation algorithm may be selected by the trading system to encourage certain trading behavior, such as to incentivize order submission, and thereby improve market liquidity, in an otherwise slow market, reward market making activity, e.g. the submission of orders at prices at which there are no current counter orders, or otherwise discourage market taking activity, e.g. the submission of orders at which there are currently available counter orders, discourage cancelation or modification of previously submitted orders, etc. It will be appreciated that there are numerous other allocation algorithms which may be implemented, each having certain benefits. As the matching process occurs, reporting mechanisms may transmit messages, such as confirmation messages, to the market participants to inform them of the status of their submitted orders and market data mechanisms may transmit data messages, i.e. market updates, to all of the market participants informing them about the state of the order book, i.e. informing them of the currently pending previously received but unsatisfied orders, and thereby the state of the market, i.e. the current market consensus of the value/price, for that particular financial product.

Current financial instrument trading systems allow traders to submit orders and receive confirmations, market data, and other information electronically via a network. These “electronic” trading systems/marketplaces have largely supplanted the pit based trading systems whereby the traders, or their representatives, all physically stand in a designated location, i.e. a trading pit, and trade with each other via oral and hand based communication. Anyone standing in or near the trading pit may be privy to the trades taking place, i.e. both who is trading and what they are trading. Electronic trading systems, in contrast, ideally attempt to offer a more efficient, fair and balanced market with increased liquidity where market prices reflect a true consensus of the value of traded products among the market participants, where the intentional or unintentional influence of any one market participant is minimized if not eliminated, and where unfair or inequitable advantages with respect to information access are minimized if not eliminated.

The speed with which trades are executed through electronic trading systems provide many benefits. Electronic trading systems can facilitate a large number of market transactions. The greater the number of market transactions, the greater a market's efficiency and liquidity. In liquid markets, prices are driven by competition; prices reflect a consensus of an investment's value; and free and open dissemination of information is provided. With the advent of improved computational and communications capabilities, the speed and efficiency with which traders may receive information and trade in electronic trading systems has greatly improved. For example, algorithmic and high frequency trading utilize computers to quickly analyze market information and place trades allowing traders to rapidly take advantage of even the smallest movements in prices.

Unfortunately, this improved speed and efficiency also improves the speed at which errors, unintended or otherwise, and/or problems may occur and propagate, such as where the market ceases to operate as intended, i.e. market liquidity is reduced and/or the market otherwise no longer reflects a true consensus of the value of traded products among the market participants.

To mitigate risk and ensure a fair and balanced market, Exchanges need to provide mechanisms to maintain or improve market efficiency and liquidity and rapidly detect and respond to situations where a market is not operating in am efficient, fair and/or balanced manner or otherwise where the market value is not reflective of a true consensus of the value of the traded products among the market participants.

### BRIEF DESCRIPTION OF THE DRAWINGS

FIG. 1 depicts an illustrative computer network system that may be used to implement aspects of the present invention

FIG. 2 depicts a block diagram of an exemplary implementation of the system of FIG. 1 for administering futures contracts, according to one embodiment.

FIG. 3 depicts a flow chart showing operation of the system of FIGS. 1 and 2.

FIG. 4 shows an illustrative embodiment of a general computer system for use with the system of FIGS. 1 and 2.

### DETAILED DESCRIPTION

The disclosed embodiments relate to protections against self-matching orders which maximize market liquidity and efficiency by reducing or minimizing unnecessary order cancelations and resubmissions. Rather than automatically cancel or modify the incoming and/or self-matching resting counter orders, the disclosed embodiments place those resting counter orders, which would result in the occurrence of a self-match with an incoming order, in a hold state or otherwise set them aside such that the incoming order may be matched with other non-self-matching orders. The held/set aside orders are then subsequently returned to the order book at the same, or alternatively at a different, priority, such as last, with respect to the remaining resting orders, to await a subsequent incoming order. Where the incoming order is not fully satisfied, only self-matching counter orders are identified or the return of the held/set aside orders would result in a crossed order book, the disclosed embodiments may allow a trader to include instructions with, and/or specific to, each order directing the response of the electronic trading system to cancel the self-matching resting orders, cancel the incoming order, decrement the larger order's quantity by the quantity of the smaller order, or take some other action with respect thereto.

As can be seen, the disclosed embodiments maximize the incoming order execution by not unnecessarily canceling or modifying orders when orders from the same entity are detected but instead setting the self-matching orders aside and allowing the incoming order to attempt to match with any remaining suitable counter orders. Furthermore, market efficiency is improved by not unnecessarily requiring traders to resubmit orders subsequent to cancelation. As the set aside orders are reentered into the order book, rather than being automatically canceled, subsequent to resolution of the self-matching situation, the trader need not resubmit their orders. This may result in reduced computational load on a trader's trade generation/submission system, reduced consumption of bandwidth between the trader's systems and the electronic trading system, reduced computational load on the electronic trading system, or a combination thereof, having to generate, communicate and process order cancelation messages and resubmitted order messages. The disclosed embodiments further improve the efficiency of order quantity allocation, in particular, pro rata quantity allocation by identifying and removing self-matching counter orders prior to the calculation of the pro rata quantity apportionment. This minimizes any need to recalculate the apportionment due to the elimination of any self-matching orders from participating in the allocation of the incoming order quantity.

As described in U.S. patent application Ser. No. 11/601,489, herein incorporated by reference, intra-firm match, also referred to herein as self-match, avoidance protections may be provided by an electronic trading system to monitor for and/or prevent a particular entity from transacting with another identified entity, e.g. itself. These systems may detect and/or prevent firms or traders from matching with themselves (or other entities with which they do not want to trade) in any of the central limit order book markets. This may be accomplished by using information related to the order at the Legal Clearing Entity (“LCE”), Legal Entity Identifier (“LEI”), Beneficial Ownership, trader, desk, or firm level of granularity. In one exemplary implementation, when an aggressor/incoming order is being matched against the resting order book and the one or more identified opposite/counter resting order(s) has/have been deemed to be unmatchable due to the determination that the submitting market participants are the same or belong to the same entity, there are several options which may be implemented: the aggressor/incoming order may be cancelled before any matching occurs; or the aggressor/incoming order matches normally and any resting order it attempts to match with, which is deemed unmatchable, may be cancelled immediately. In either case, appropriate fill and cancellation messages are sent to the parties involved, per normal operations of those actions (order cancel and trade). As will be described in more detail below, other actions may also be implemented which attempt to avoid unnecessary order cancelations, provide control to the affected trading entities and otherwise avoid unwarranted impediments to trading and reductions in market liquidity.

An intra-firm match, otherwise referred to as a self-match, is a transaction where the same entity is effectively on both sides, of the transaction, e.g. the same entity has two pending opposing orders, a buy and a sell, which match or are otherwise counter to each other. This can happen because within any given entity, there may be many traders or many sub-entities, e.g. business units, which are individually authorized to place orders with the Exchange and these traders or sub-entities, or the orders that they place, may not always identify that they are a part of the larger entity. While intra-firm/self-matches are generally referred to as matches among the same entity, it will be appreciated that the “same entity” for the purposes of self-match identification and the application of the mechanisms described herein may refer to entities which may be otherwise unrelated but for a requirement or their desire to utilize these mechanisms to prevent trades there between and, for the purposes of this disclosure, such entities will be referred to as the “same.”

Further, it is not always clear, based on the orders alone, that particular trading entities, are in fact, sub-entities of the same larger entity or that matching there between is undesirable. Generally, orders are matched in an electronic trading system 100 based on the nature and subject of the transaction, e.g. buy vs. sell for the same specified product at a particular price. It is further not always clear whether order placed by a given entity, referred to as a proxy entity, are in fact placed on behalf of another entity or that matching there between is undesirable. In this case, if the order matches with another entity that is in fact related to the proxy entity, rather than the underlying entity, there may be no issue and no reason to take any action. Accordingly, not all intra-firm matches are undesirable or improper but generally, where undesirable or improper matches occur (these being referred to as “unmatchable”), such trades may result in unnecessary transaction fees, e.g. the entity could have just traded internally rather than incur the costs associated with trading via the electronic trading system 100, may be counter to the rules of the Exchange or the trading entity, may have a detrimental effect on the market, e.g. by reducing liquidity, and/or may have possible legal or regulatory implications, e.g. the transactions may violate SEC, accounting or anti-trust rules, such as by creating fictitious volume. Identification of such intra-firm matches is therefore desirable. In some implementations, once identified, various actions may be taken such as canceling the incoming and/or resting order(s) or merely notifying the parties that originated the orders so that they may internally resolve any systemic problems and/or avoid future occurrences. Prior detection methods relied on post-transaction audits to identify these events. While such post-transaction detection may aid in preventing future occurrences of intra-firm matches, it makes dealing with the specific transactions that have already occurred difficult.

As discussed above, a given trading entity may include a collection or hierarchy of sub-entities or business units. For example, a given trading entity may include a trading firm, a clearing firm or a trading firm that is also a clearing firm. Within trading/clearing firms, there may be one or more trading desks, traders, customers, clerks or other sub-entities or combinations thereof. Any of these entities may act, e.g. place orders, on behalf of themselves and/or other entities, such as customers or other trading firms. For example a larger trading firm may act as a surrogate for a smaller trading firm. Further, the authority under which a given entity, or sub-entity thereof, may act may overlap with the authority granted to another entity or sub-entity. It will be appreciated, that the organization of a given entity as a collection and/or hierarchy of sub-entities may vary and that all such organizations are contemplated. As used herein, any two sub-entities may be considered to be part of the same entity, or not, based on the intent of each sub-entity or the entity to which they belong. For example, two trading desks of the same trading firm, each trading on behalf of a different customer, may not be considered to be part of the same entity and transactional matches between their orders may be permitted. In contrast, two trading desks of the same trading firm, each trading on behalf of the trading firm, may be considered part of the same entity and transaction matches between their orders may be, for example, denied or otherwise flagged. In addition, an entity, or sub-entity thereof, may explicitly specify other entities, or sub-entities thereof, that they wish not to trade with regardless of their affiliation, either by specifically identifying the entity or sub-entity they wish to avoid, by specifying attributes, or the type, of an entity or sub-entity they wish to avoid, or combinations thereof. For example, entities or sub-entities may specify who they will or will not trade with based on the credit risk/rating of the potential counter-party or based on a business agreement that they have in place, etc. Further, whether two sub-entities are considered to be part of the same entity, or not, may vary, such as over time. For example, during regular trading hours (“RTH”), two particular sub-entities may be considered part of the same entity for the purposes of detecting intra-firm matches. However, during extended trading hours (“ETH”), the same two sub-entities may not be considered part of the same entity, allowing for different treatment. As will be described below, the determination of sub-entities as being part of the same entity may be implemented so as to control what factors trigger a match and which do not. Alternatively, or in addition thereto, the actions selected to be performed based on a match may be implemented so as to take certain actions or not, based on other parameters. For example, the system may either be configured so as to not flag two particular sub entities as being part of the same entity or the system may be alternatively configured to take no action if the two sub-entities are determined to be part of the same entity, with the net result being substantially similar. Preventing the match from occurring as opposed to detecting the match but taking no action may each have their own advantages such as for audit or reporting purposes.

In one exemplary implementation, entities may voluntarily assess their need for self-match protections within their own organizational hierarchy, register with the electronic trading system 100 for self-match protections, such as via a web based user interface, and be issued one or more unique identifiers, e.g. the self-match identifier described below, which they may then include in all orders that they submit, such as by programming the identifiers into their electronic order generation/submission systems, such that the electronic trading system may identify self-match situations based thereon as described below. The electronic trading system 100 may then maintain, such as part of the user account data 102, 104, a registry of identifiers associated with each registered trading entity. Using multiple identifiers, a given organization may compartmentalize the application of self-match protections within and among their various constituent entities. Unregistered trading entities need not include any identifiers in their orders and, therefore, may not be subject to the application of the described self-match mechanisms. It will be appreciated that registration and application of self-match protections may be mandatorily implemented.

The disclosed embodiments may detect the occurrence of two sub-entities of the same entity attempting to transact, referred to herein as an intra-firm or self-match, analyze the transaction and apply one or more rules, i.e. take one or more actions, to handle the transaction. The action to be taken may be based on preferences and/or regulations of the Exchange, the participating entities, governing regulations/laws, or combinations thereof. In one embodiment, the handling of a transaction between two sub-entities of the same entity may depend on where the transacting sub-entities are located, organizationally, within the hierarchy of sub-entities of the entity, e.g. two sub-entities at the same “level” may or may not be allowed to transact. Business relationships may be further considered so as to avoid any nuisance, unnecessary order cancelations, or unnecessary fees, and generally maintain a good relationship between the electronic trading system 100 and the entities that trade thereon. The selected action(s) may vary dynamically based on other parameters, such as time of day described above, e.g. RTH or ETH, day of week, month, or some varying characteristic of the entities and/or sub-entities involved. For example, during RTH, intra-firm match transactions may be blocked whereas during ETH, they are permitted.

Exemplary actions to be taken when an intra-firm match is detected are: take no action and fill both orders; notify one or more of the parties involved and/or the operator of the electronic trading system 100 of the detected intra-firm match where the notification may or may not identify one or more of the parties to each other; fill the order pending approval of one or more of the parties and/or the operator of the electronic trading system 100, a regulatory agency, a governmental agency, trade/industry organization or combination thereof; cancel both orders; cancel one of the orders based on a defined algorithm, such as canceling the incoming/aggressor order and maintaining the resting order or vice versa, canceling the smaller order, canceling one of the orders based on a priority, hierarchical or other attribute of the order; fill as much of each order against other non-intra-firm-match matching orders, on a priority or non-priority basis, and then take a defined action with any unfilled remainder, such as cancel it; leave the orders unfilled, i.e. crossed, on the order book so as to match with other non-intra-firm-match orders (crossed orders are orders at the same price on opposite sides of a transaction that would normally match but which are prevented from doing so); complete the transaction, i.e. fill both orders, but either at a lower or zero cost or at a higher cost, possibly dependent on the relationship between the parties and the Exchange and the preferences thereof, decrement the quantity of the larger order by the quantity of the smaller order, or combinations thereof. One, or a combination, of these action may be defined as the default action to take, unless otherwise specified or overridden, in an intra-firm match situation. For example, no matter what other action is taken, the parties involved and/or the Exchange may be notified that an intra-firm match was detected. As will be described below, the action to take may be specified by the affected trading entities, such as via instructions included in either the incoming order, the resting order(s) or both.

In one exemplary system for detecting and handling intra-firm matches among market participants transacting via an electronic trading system 100, described in more detail below, in order to identify intra-firm matching orders, also referred to as intra-firm matches or self-matches, the system needs to be able to identify the source of a given order so as to be able to determine whether the same entities, i.e. two or more entities for which trading there between is to trigger the mechanisms described herein, are in fact dealing with each other. As will be described, this may be accomplished via the assignment of an identifier or combination of identifiers to an entity and the inclusion of these identifiers with each submitted order. In one exemplary embodiment, each entity may be assigned an identifier, e.g. an Executing Firm Identifier (“EFID”), which identifies the trading entity, and one or more self-match identifiers (“SMID”), which the trading entity may assign to the various sub-entities among which it wishes to restrict self-matching where a self-match may be identified when an order are submitted by entities with the same EFID and include therein the same SMID. This may permit a given trading entity to control the application of the mechanisms described herein. It will be appreciated that there may be other mechanisms of identifying self-matching orders for the purpose of applying the mechanisms described herein, not the least which includes assigning a singular entity identifier to each trading entity which is used to identify each order submitted thereby and determining a self-match when two orders contain the same identifier. Other mechanisms of identifying orders submitted by the same entity may be used, alone or in combination with the mechanisms described above, and are implementation dependent, such as identifying orders submitted from the same geographic location and/or logical/network location, e.g. internet protocol (“IP”) address, internet subnet or domain, submitting device media access control (“MAC”) address, proxy server address, router MAC address, network node, peering point, cell tower, or combinations thereof, etc. Once an intra-firm match is identified, the system may execute one or more defined actions and/or apply one or more rules, such as stopping the firms from matching with each other or implementing a priority matching scheme.

The exemplary system may include an intra-firm match detector, which will be described in more detail below, coupled with the matching, clearing and settlement functionality of the electronic trading system 100 described in more detail below. In particular, the intra-firm match detector may be coupled with the matching engine 106 so as to intercept potential intra-firm match transactions, i.e. an incoming order to buy or sell received from a particular trading entity/market participant, before it is matched against one or more previously received, but unsatisfied, i.e. “resting”, order(s) from the same entity, and subsequently determine what actions are to be taken. In an alternate embodiment, the intra-firm match detector may be a part of the matching engine 106. The intra-firm match detector may include an identity identifier and a transaction/order processor coupled with the identity identifier. In one embodiment, the intra-firm match detector may further include an identity database coupled with the identity identifier or identity data may be stored in the account or user databases 102, 104. The trading entities/market participants may comprise a trading firm, clearing firm, trading desk, trader, customer, clerk, or combination thereof.

The transaction/order processor may be operative to first establish that the incoming/aggressor order is at least partially counter to the resting order(s), i.e. if the orders do not match, then the trading entities and their relationship are irrelevant for the disclosed functionality since no trade would occur regardless. However, if the incoming and resting orders are at least partially matching, the identity identifier, coupled with the order processor, may be operative to identify whether the first trading entity is permitted to transact with the second trading entity based on a relationship there between as described herein. For example, as was described above, each order/transaction may include one or more identification codes which may used to identify the trading entity. While the embodiments described herein may first determine which, if any, resting orders match or potentially match the incoming order before determining whether the involved trading entities are the same, it will be appreciated that the trading entities of incoming order and all, or a subset, of the resting orders on the order book may first be determined before it is determined whether any of those resting orders are counter to the incoming order. Further, as will be described, whether one order is counter to another order may be determined separately from the determination of how much quantity of the incoming order will be allocated to the suitably counter resting order(s). For example, the subset of resting orders which are counter to the incoming order may be determined prior to the determination of how much of the quantity of the incoming order may be allocated to each determined counter resting order, which may ultimately be determined to be zero. Where the incoming order does not have sufficient quantity to satisfy all of the determined resting counter orders, the electronic trading system 100 may apply allocation algorithms, such as first-in-first-out (“FIFO”), pro rata, or other algorithm or combination thereof to apportion the incoming order quantity. As will be described, the self-match prevention mechanisms may be applied subsequent to the determination of the suitable resting counter orders but prior to, or contemporaneously with, the determination of the incoming quantity allocation thereto. For example, if the incoming quantity is insufficient to satisfy all of the resting counter orders, one or more of which are from the same entity as the incoming order, and the allocation algorithm would result in the orders from the same entity receiving none of the incoming quantity, then there may be no need to initiate the self-match prevention mechanisms described herein, resulting in a reduced computational load on the electronic trading system 100. As a pro rata allocation algorithm generally requires that all of the eligible resting counter orders be identified so that inter-order quantity allocation proportions can be determined, it is advantageous to apply the self-match prevention mechanisms described herein prior to the application of the pro rata algorithm so as to, for example, eliminate any unmatchable orders from contending for a portion of the incoming quantity. If self-match identification were applied after the application of the pro rata algorithm, the algorithm may need to be reapplied/recalculated, increasing the computational load on the electronic trading system 100, if self-matching orders were identified and the prevention of matching thereof was desired.

In one embodiment, the identification code encodes identity information, such as information which identifies the trading firm hierarchy to which the entity belongs, e.g. the identification code may be a concatenation of multiple codes representative of the hierarchy of entities to which the given trading entity belongs. In one embodiment, the identification code, or a portion thereof, may be an arbitrary identifier provided to a trading entity for inclusion in orders from those sub-entities thereof for which the trading entity wish to apply self-match protections. The identification codes of the various transactions may then be compared to determine if an intra-firm match exists. In one embodiment, the identification codes are matched and/or compared in an ordered fashion, such as by performing a logical operation on binary representations thereof, on each component identification code representative of the hierarchy of entities. For example, the codes may be related together using a logical exclusive-or function, bit masks, other Boolean logic, a state machine or pattern matching mechanism, or combination thereof, the results of which may be used to determine whether a suitable match exists. The identity identifier may be further programmed with rules as to what constitutes an intra-firm match, such as what portion of the identification codes must match, if less than all. In an alternate embodiment, the identity identifier may be coupled with an identity database or an account or user database 102, 104. In one implementation, the identifier included in the orders may be unique to each order whereby the electronic trading system maintains a database associating those unique identifiers with the identity of the trading entity. The identification codes provided in the orders may then be used to look up the entities in the database for subsequent comparison to determine if a match exists. Such an implementation may prevent third parties from monitoring the trading activity of a given trading entity by intercepting order submissions.

Where the first trading entity is related to a third trading entity and the second trading entity is related to a fourth trading entity, the identity identifier may be further operative to identify whether the first trading entity is permitted to transact with the second trading entity based on a relationship between the third and fourth entities. For example, the first trading entity may be a sub-entity of the third trading entity and the second trading entity may be a sub-entity of the fourth trading entity. In one embodiment, the first and second trading entities may be identified by the identity identifier as being related when the relationship comprises the first and second trading entities being at least part of a common entity, when the relationship comprises the first and second trading entities being the same entity, when the relationship comprises the first and second trading entities being contractually related to each other, when the relationship comprises a specification by one of the first and second trading entities of the other of the first and second entities, or combinations thereof. Where one entity specifies that transactions with another entity should result in an intra-firm match, the specification may specifically identify entities or the specification may be a general specification of a category of entities comprising the other of the first and second entities, such as a credit rating of entities that should or should not cause an intra-firm match. It will be appreciated that a particular trading entity may arbitrarily specify which other entities to which it does or does not want the application of self-match protection, e.g. the entities need only agree to include the requisite identification codes in their orders. Further more, the specification of which entities to apply self-match protections, as described herein, may be specified by the operator of the electronic trading system, a governmental, regulatory, or industry/trade organization, or a combination thereof, including in combination with the trading entities themselves.

The transaction/order processor may be coupled with the identity identifier and operative to allow the incoming order to be matched to the resting counter order(s) where the first trading entity which submitted the incoming order is identified as being unrelated to the second trading entity(ies) which submitted the resting order(s) and the incoming order is at least partially counter to the resting order(s). The transaction processor may be further operative to determine an action to take with respect to the incoming and resting order(s) when the first trading entity is identified as being related to the second trading entity. The action may be based on business rules that are stored in the identity database, such as rules associated with either of the trading entities, or as will be described below, rules or instructions provided in the orders themselves, e.g. as part of the Financial Information eXchange (“FIX”) protocol. The rules/instructions may be specified, for example, by the Exchange, the trading entities, government regulators, or combinations thereof.

For example, the action may include notifying the first and second trading entities of the relation, canceling the incoming and/or resting order(s), matching the incoming order to the resting order(s), allowing the incoming order to be matched only to other resting counter orders not submitted by the same entity, or combinations thereof. In one embodiment, the action may further include charging one of a standard transaction fee, a lower transaction fee, a higher transaction fee or no transaction fee.

In one embodiment the intra-firm match detector may include one or more processors, one or more memories and/or other storage media coupled with the one or more processors and a network interface coupled with the one or more processors and a network operative to facilitate communications there between and with the electronic trading system 100, or one or more components thereof, and market participants. Each of the identity identifier, transaction/order processor, and identity database may be implemented in hardware, processor-executable software/logic or a combination thereof. While various components are discussed in terms of their discrete functions, it will be further appreciated that one or more of the described functions may be implemented in a single component or any one function may be performed by multiple discrete components, or combinations thereof, and is implementation dependent.

For example, the matching of a first order received from a first trading entity with a second order received from a second trading entity may include a processor and a memory coupled with the processor, the system further including: first logic stored in the memory and executable by the processor to establish that the first order is at least partially counter to the second order; second logic stored in the memory and executable by the processor to identify whether the first trading entity is permitted to transact with the second trading entity based on a relationship there between; third logic stored in the memory and executable by the processor to allow the first order to be matched to the second order where the first trading entity is identified as being unrelated to the second trading entity and the first order is at least partially counter to the second order; and fourth logic stored in the memory and executable by the processor to determine an action to take with respect to the first and second orders when the first trading entity is identified as being related to the second trading entity.

Exemplary operation of the system described above may include establishing that the first order is at least partially counter to the second order and identifying whether the first trading entity is permitted to transact with the second trading entity based on a relationship there between. Alternately, it will be appreciated that the trading entities, and whether they match, may first be determined prior to determining whether in incoming order is counter to a resting order. Wherein the first trading entity is related to a third trading entity and the second trading entity is related to a fourth trading entity, the identifying may further include identifying whether the first trading entity is permitted to transact with the second trading entity based on a relationship between the third and fourth entities. The first trading entity may be a sub-entity of the third trading entity and the second trading entity may be a sub-entity of the fourth trading entity. The identifying may further include identifying the first and second trading entities as being related when the relationship comprises the first and second trading entities being at least part of a common entity, when the relationship comprises the first and second trading entities being the same entity, when the relationship comprises the first and second trading entities being contractually related to each other, when the relationship comprises a specification by one of the first and second trading entities of the other of the first and second entities, or combinations thereof. Where a specification is provided, the specification may include identification of a specific entity or a general specification of a category of entities, e.g. credit rating, etc., comprising the other of the first and second entities, or combinations thereof.

The operation may further include allowing the incoming order to be matched to the resting order where the first trading entity is identified as being unrelated to the second trading entity and the incoming order is at least partially counter to the resting order(s) and determining an action to take with respect to the incoming and resting orders when the first trading entity is identified as being related to the second trading entity. In one embodiment, the action comprises notifying the first and second trading entities of the relation, canceling the incoming and/or resting orders, matching the incoming order to the resting order(s), allowing the incoming order to be matched to other resting orders but not to entity-matching order, or combinations thereof. The action may further include charging one of a standard transaction fee, a lower transaction fee, a higher transaction fee or no transaction fee.

While the disclosed embodiments may be described with reference to their applicability to electronic trading systems which trade futures contracts, and derivatives thereof, it will be appreciated that they may be applicable to any electronic trading system, e.g. which trade derivatives, equities or other products. Furthermore, in electronic trading systems 100 which implement implied order processing, whereby order matching opportunities are generated or identified across different order books/markets to improve market liquidity when individual and combination financial products are offered for trading, the disclosed embodiments may be implemented so as to extend the self-match protection mechanisms, as described herein, to these implied orders/markets, such as by causing any implied orders listed in an order book to inherit or otherwise be associated with the entity identifier(s) of the “real” order from which the implied order was created. In an alternate implementation, self-match protections may be applied only to matching between real/outright orders. Herein, when referring to “resting” orders on the order book, such orders may be real/outright or implied orders.

It will be appreciated that a trading environment, such as a futures exchange as described herein, implements one or more economic markets where rights and obligations may be traded. As such, a trading environment may be characterized by need to maintain market integrity, transparency, predictability, fair/equitable access and participant expectations with respect thereto. For example, an exchange must respond to inputs, such as trader orders, cancellation, etc., in a manner as expected by the market participants, such as based on market data, e.g. prices, available counter-orders, etc., to provide an expected level of certainty that transactions will occur in a consistent and predictable manner and without unknown or unascertainable risks. In addition, it will be appreciated that electronic trading systems further impose additional expectations and demands by market participants as to transaction processing speed, latency, capacity and response time, while creating additional complexities relating thereto. Accordingly, as will be described, the disclosed embodiments may further include functionality to ensure that the expectations of market participants are met, e.g. that transactional integrity and predictable system responses are maintained.

Generally, the disclosed embodiments, rather than automatically cancel or modify the incoming and/or self-matching resting counter orders, which may be simpler to implement, place those resting counter orders, which would result in the occurrence of a self-match with an incoming order, in a hold state or otherwise set them aside such that the incoming order may be matched with other non-self-matching orders. The held/set aside orders are then subsequently returned to the order book at the same, or alternatively at a different, priority, such as last, with respect to the remaining resting orders, to await a subsequent incoming order, thereby maintaining order book depth and liquidity. In implementations where set-aside orders retain their order book priority, traders do not automatically lose favorable book/queue position when self-matches are detected. Where the incoming order is not fully satisfied, only self-matching counter orders are identified or the return of the held/set aside orders would result in a crossed order book, the disclosed embodiments may allow a trader to include instructions with, and/or specific to, each order directing the response of the electronic trading system to cancel the self-matching resting orders, cancel the incoming order, decrement the quantity of the larger order by the quantity of the smaller order, or take some other action with respect thereto.

While the disclosed embodiments are more complicated to implement, other self-match prevention implementations do not maximize trade volume or order book liquidity because they simply cancel self-matching orders from the order book or otherwise prevent incoming/aggressor orders from trading with the maximum available quantity in the order book. By not unnecessarily canceling or modifying orders when orders from the same entity are detected but instead setting the self-matching orders aside and allowing the incoming order to attempt to match with any remaining suitable counter orders, order execution volume is maximized. Furthermore, market efficiency is improved by not unnecessarily requiring traders to resubmit orders subsequent to cancelation. As the set aside orders are reentered into the order book, rather than being automatically canceled, subsequent to resolution of the self-matching situation, the trader need not resubmit their orders. This may result in reduced computational load on a trader's trade generation/submission system, reduced consumption of bandwidth between the trader's systems and the electronic trading system, reduced computational load on the electronic trading system, or a combination thereof, having to generate, communicate and process order cancelation messages and resubmitted order messages. The disclosed embodiments further improve the efficiency of order quantity allocation, in particular, pro rata quantity allocation by identifying and removing self-matching counter orders prior to the calculation of the pro rata quantity apportionment. This minimizes any need to recalculate the apportionment due to the elimination of any self-matching orders from participating in the allocation of the incoming order quantity.

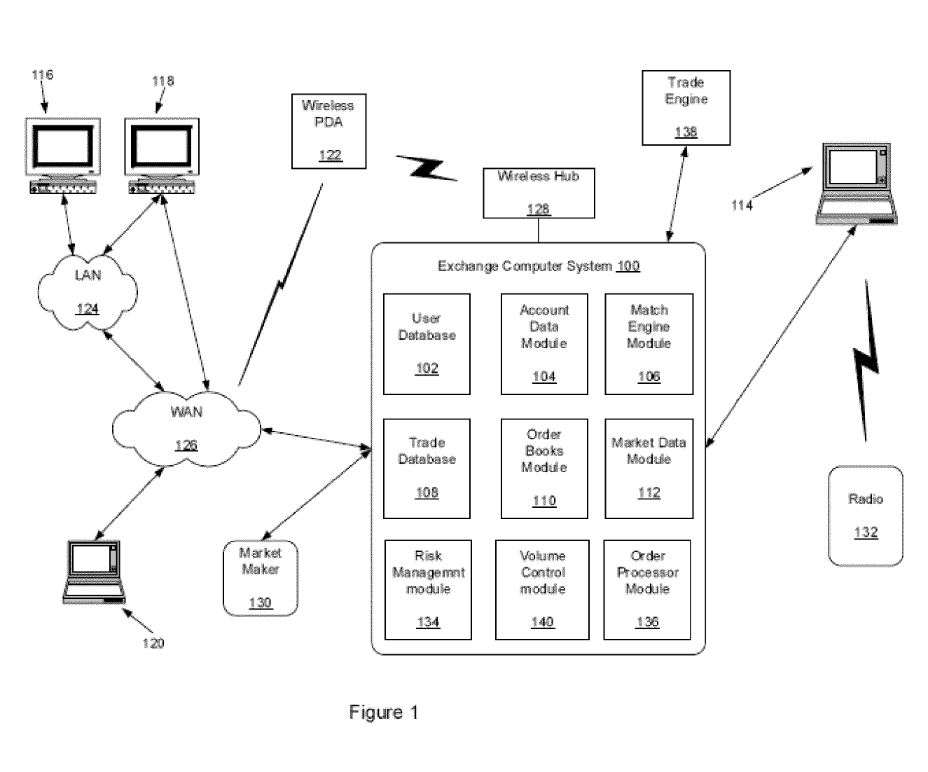

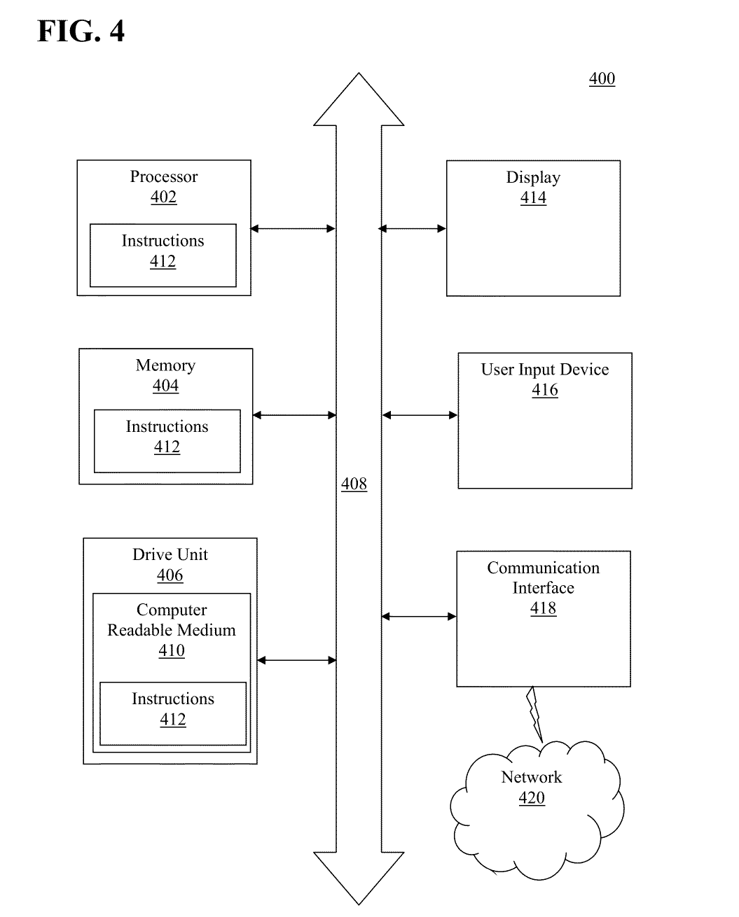

The disclosed embodiments are preferably implemented with computer devices and computer networks, such as those described with respect FIG. 4, that allow users, e.g. market participants, to access exchange trading information. It will be appreciated that the plurality of entities utilizing the disclosed embodiments, e.g. the market participants, risk managers, market makers, brokers, dealers, etc., may be referred to by other nomenclature reflecting the role that the particular entity is performing with respect to the disclosed embodiments, and may refer to a corporate or organizational entity and/or to an employee or agent thereof, and that a given entity may perform more than one role depending upon the implementation and the nature of the particular transaction being undertaken, as well as the entity's contractual and/or legal relationship with another market participant and/or the exchange. An exemplary trading network environment for implementing trading systems and methods is shown in FIG. 1. An exchange computer system 100 receives orders and transmits market data related to orders and trades to users, e.g. market participants, such as via computer devices 114, 116, 118, 120 and 122, as will be described below, coupled with the exchange computer system 100. As used herein, an exchange 100 includes a place or system that receives and/or executes orders for traded products.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The exchange computer system 100 may be implemented with one or more mainframe, desktop or other computers, such as the computer 400 described below with respect to FIG. 4. A user database 102 may be provided which includes information identifying market participants, e.g. traders and other users of exchange computer system 100, such as account numbers or identifiers, user names and passwords. An account data module 104 may be provided which may process account information that may be used during trades and, as will be described below, may be used to store trading entity identifiers associated with each participating trading entity as described below. A match engine module 106 may be included to match bid and offer prices and may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices for one or more products. A market data module 112 may be included to collect market data and prepare the data for transmission to users. A risk management module 134 may be included to compute and determine a user's risk utilization in relation to the user's defined risk thresholds as will be further described below. An order processing module 136 may be included to decompose delta based and bulk order types for processing by the order book module 110 and/or match engine module 106. A volume control module 140 may be included to, among other things, control the rate of acceptance of mass quote messages.

The trading network environment shown in FIG. 1 includes exemplary computer devices 114, 116, 118, 120 and 122 which depict different exemplary methods or media by which a computer device may be coupled with the exchange computer system 100 or by which a user/market participant may communicate, e.g. send and receive, trade or other information therewith. It will be appreciated that the types of computer devices deployed by market participants and the methods and media, including wired and/or wireless media, by which they communicate with the exchange computer system 100 is implementation dependent and may vary and that not all of the depicted computer devices and/or means/media of communication may be used and that other computer devices and/or means/media of communications, now available or later developed may be used. Each computer device 114, 116, 118, 120 and 122, which may comprise a computer 400 described in more detail below with respect to FIG. 4, may include a central processor that controls the overall operation of the computer and a system bus that connects the central processor to one or more conventional components, such as a memory, data storage, network card or modem. Each computer device 114, 116, 118, 120 and 122 may also include a variety of interface units and drives for reading and writing data or files and communicating with other computer devices and with the exchange computer system 100. Depending on the type of computer device 114, 116, 118, 120 and 122, a user can interact with the computer with a keyboard, pointing device, touch interface, microphone, pen device or other input device now available or later developed.

An exemplary computer device 114 is shown directly connected to exchange computer system 100, such as via a T1 line, a common local area network (LAN) or other wired and/or wireless medium for connecting computer devices. The exemplary computer device 114 is further shown connected to a radio 132. The user of radio 132, which may include a cellular telephone, smart phone, or other wireless proprietary and/or non-proprietary device, may be a market participant, e.g. trader, or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known.

As was described above, the users, i.e. market participants, of the exchange computer system 100 may include one or more market makers 130 which may maintain a market by providing constant bid and offer prices for a derivative or security to the exchange computer system 100, such as via one of the exemplary computer devices depicted. The exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may include other components not shown and be connected by numerous alternative topologies.

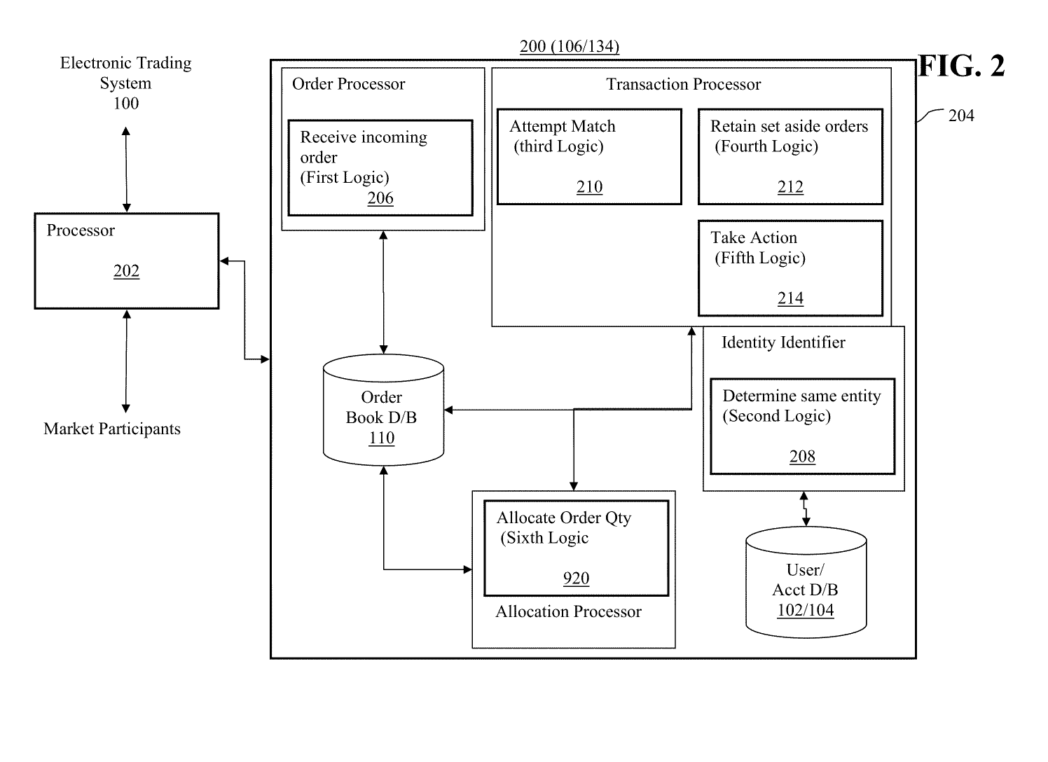

As will be described, the disclosed embodiments may be implemented as part of the Risk Management Module 134 and/or Match Engine Module 106 as will be describe with reference to FIG. 2. However, it will be appreciated that the disclosed mechanisms may be implemented at any logical and/or physical point(s), or combinations thereof, at which the relevant information/data may be monitored or is otherwise accessible or measurable, including one or more gateway devices, modems, the computers or terminals of one or more market participants, etc.

FIG. 2 depicts a block diagram of a system 200, which may be referred to as a “self-match protection” system, for detecting and responding to the occurrence of matches between orders from the same entity, which in an exemplary implementation, may be implemented as part of the risk management module 134 and/or Match Engine Module 106 of the exchange computer system 100 described above. The financial instrument may be financial derivative product including futures contracts, options on futures contracts, futures contracts that are functions of or related to other futures contracts, swaps, swaptions, or other financial instruments that have their price related to or derived from an underlying product, security, commodity, equity, index, or interest rate product. In one embodiment, the orders are for options contracts that belong to a common option class. Orders may also be for baskets, quadrants, other combinations of financial instruments, etc. The option contracts may have a plurality of strike prices and/or comprise put and call contracts.

FIG. 2 shows a system 200 for managing incoming order allocation in an electronic trading system 100 for a product traded on an exchange, such as a financial instrument, e.g. futures contracts, options contracts, etc., the electronic trading system 100 comprising a processor 106 which implements a match engine and electronic market for an associated financial instrument by being operative to attempt to match an incoming order to buy or sell the associated financial instrument with at least one other previously received but unsatisfied order for a transaction counter thereto stored in an order book database 110 coupled with the processor 106, to at least partially satisfy one or both of the incoming order or the at least one other previously received order, and, subsequent thereto, store data indicative of any unsatisfied remainder of the incoming order or the at least one other order in the order book database for a subsequent attempt to match against a later received incoming order The system 200 includes a processor 202 and a memory 204 coupled therewith which may be implemented as a processor 402 and memory 404 as described below with respect to FIG. 4 and/or may be the same as the processor 106 which implements the match engine. The system 200 further includes an order processor 206 which may be implemented as first logic 206 stored in the memory 204 and executable by the processor 202 to cause the processor 202 to receive, from a market participant, an incoming order to buy or sell the associated financial instrument, the order further comprising data identifying an entity to which the order is associated. In one embodiment, the system 200 is coupled with the user database 102, account data module 104, match engine module 106, and/or order books module 110 described above and monitors the relevant parameters of the incoming orders and order book maintained for the product. It will be appreciated that the system 200 may be coupled with other modules of the exchange computer system 100 so as to have access to the relevant parameters as described herein and initiate the requisite actions as further described. The disclosed embodiments may be implemented separately for each market/order book to be monitored, such as a separate process or thread, or may be implemented as a single system for all markets/order books to be monitored thereby. In one embodiment, data representative of the trading entity identifiers may be stored in the memory 204 or elsewhere, such as in the user database 102 or account data module 104.

The system 200 further includes an identity identifier 208 which may be implemented as second logic 208 stored in the memory 204 and executable by the processor 202 to cause the processor 202 to identify a subset of the previously received but unsatisfied orders stored in the order book database 110 which are counter to the incoming order. Wherein the incoming order is characterized by a price, the identity identifier may be further operative to identify the subset of the previously received but unsatisfied orders stored in the order book characterized by a price that is identical and/or better than the price of the incoming order. It will be appreciated that if there are no such orders, the incoming order will simply be placed/rested on the order book database 110.

The system 200 further includes a transaction processor 210 which may be implemented as third logic 210 stored the memory 204 and executable by the processor 202 to cause the processor 202 to attempt to match the incoming order only with those, if any, of the identified subset of the previously received but unsatisfied orders which are not associated with the entity.

The transaction processor 210 may be further implemented by fourth logic 212 stored the memory 204 and executable by the processor 202 to cause the processor 202 to, when the incoming order is fully satisfied, retain (or otherwise reinsert) those orders, if any, of the identified subset of the previously received but unsatisfied orders in the order book database 110 that are associated with the entity for subsequent attempts to match with later received incoming orders. In one embodiment, the transaction processor may be further operative to retain (or otherwise reinsert) those orders of the identified subset of the previously received but unsatisfied orders in the order book database that are associated with the entity at a priority level commensurate with a time at which they were received by the processor, e.g. at their original priority level with respect to the other resting orders. In one embodiment, the transaction processor may be further operative to retain (or otherwise reinsert) those orders of the identified subset of the previously received but unsatisfied orders in the order book database that are associated with the entity at a priority level commensurate with having just been received by the processor, e.g. last in priority relative to the other resting orders, i.e. the back of the queue. This may avoid any perception of an unwarranted advantage being accorded to these orders. It will be appreciated that the those orders of the identified subset of the previously received but unsatisfied orders in the order book database that are associated with the entity may be retained (or otherwise reinserted) at a different priority level, such as a midpoint, time weighted or otherwise, between the priority level commensurate with a time at which they were received by the processor and the priority level commensurate with having just been received by the processor.

In one embodiment, the self-match mechanism is implemented separately from the order matching process. In this implementation, the identity identifier 208 and transaction processor 210 may be separate from the processor which implements the match engine and once self-matching resting counter orders are identified in the order book, removes those orders from the order book database 110, such as by moving them to a temporary buffer memory or storage, allowing the matching and order quantity allocation process to continue against the now-modified order book 110 with these processes effectively being unaware of the removed orders and without having to be modified to accommodate the self-match protection mechanisms. Once the matching and allocation processes are completed, as described herein, the removed order(s) may then be reinserted or otherwise put back into the order book database 110 as described. In one implementation, the removed orders may be caused to be resubmitted via the order submission mechanisms of the trading system which, by default then adds them to the order book database 110 and ascribes them with a priority commensurate with being just received, i.e. last, with respect to the other resting orders, a priority commensurate with when they were actually received, i.e. their original priority, or at some other priority level, such as a mid-point, time weighted or otherwise, between the original time of receipt and the current time. Alternatively, the self-match protection mechanisms described herein may be integrated with, or otherwise a part of the matching and allocation processes whereby identified self-matching resting counter orders are retained in the order book database and identified to the matching and allocation processes, such as via an indicator flag associated with each such order in the order book database 110, to cause the matching and allocation processes to ignore those orders during the matching and allocation process. Subsequent thereto, the indicator/flag may be reset to effectively re-enable those orders for later matching/allocation. As described, these re-enabled orders may further have their queue priority left alone or altered.

The transaction processor 210 may be further implemented by fifth logic 214 stored the memory 204 and executable by the processor 202 to cause the processor 202 to, when the incoming order is not fully satisfied, take an action in accordance with instructions included in the incoming order and/or those orders of the identified subset of the previously received but unsatisfied orders in the order book database that are associated with the entity. In one embodiment, the action may include canceling any unsatisfied remainder of the incoming order, canceling those orders of the identified subset of the previously received but unsatisfied orders in the order book database that are associated with the entity, decrementing/reducing the quantity of the larger of the incoming order or those orders of the identified subset of the previously received but unsatisfied orders in the order book database that are associated with the entity by the quantity of the smaller thereof, or a combination thereof. Where the larger order is decremented by the quantity of one more resting orders for a lesser total quantity, the smaller resting orders may then be canceled (with the appropriate parties being notified, etc.). When the total quantity of all identified resting orders exceeds the incoming order quantity, the resting orders may be decremented in a similar manner to matching, e.g. the resting orders are decremented FIFO, pro rata or combinations thereof, with the appropriate parties being notified of the modifications.

In one embodiment, the transaction processor 210 may be further operative to determine that a previously received but unsatisfied order of the identified subset of previously received but unsatisfied orders is not associated with the entity based on a comparison of an identifier included in the previously received but unsatisfied order and an identifier included in the incoming order.

In one embodiment, the system 200 may further include an allocation processor 216, implemented as sixth logic 216 stored in the memory and executable by the processor 202 to cause the processor to, wherein the incoming order and each of the identified subset of previously received but unsatisfied orders not associated with the entity are characterized by an order quantity, allocate, by the processor, the order quantity of the incoming order to one or more of the identified subset of previously received but unsatisfied orders not associated with the entity based on the order quantities thereof. In one embodiment, the allocation processor may be further operative to allocate according to a FIFO algorithm, a pro rata algorithm, or a combination thereof. It will be appreciated that other allocation methods/algorithms, such as those mentioned above, may be used.

In one embodiment, if retention, by the transaction processor, those orders of the identified subset of the previously received but unsatisfied orders in the order book database that are associated with the entity for subsequent attempts to match with later received incoming orders would result in a crossed order book, the transaction processor being further operative to take an action in accordance with instructions included in the incoming order and/or those orders of the identified subset of the previously received but unsatisfied orders in the order book database that are associated with the entity

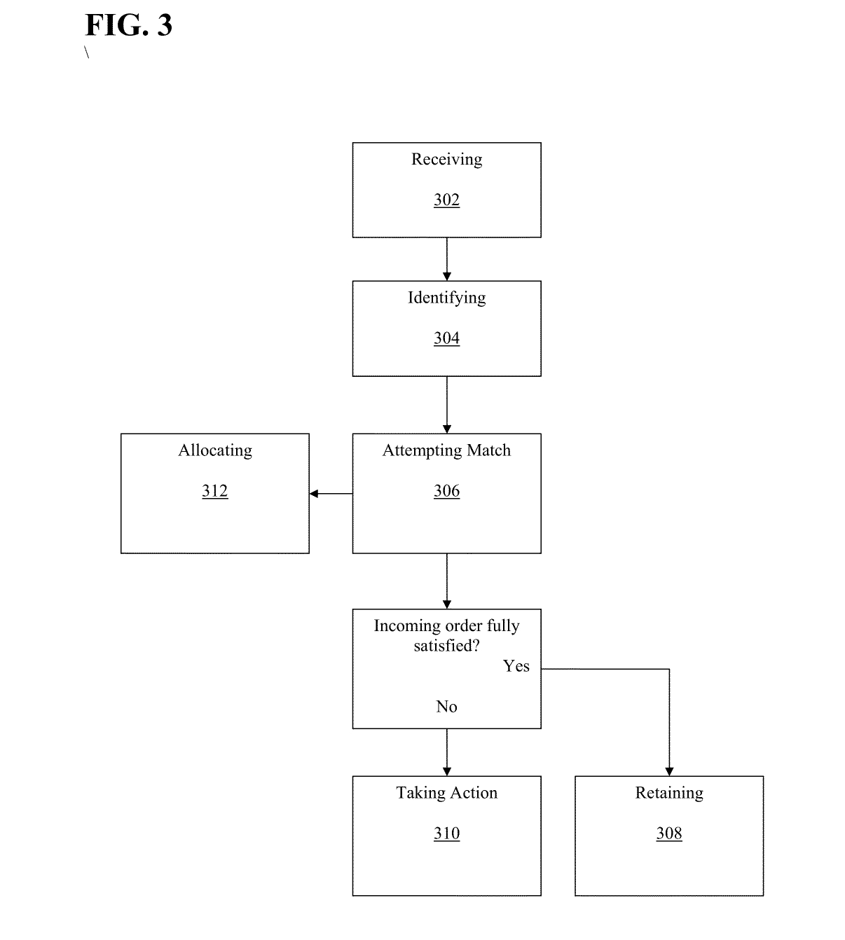

FIG. 3 depicts a flow chart showing operation of the system 200 of FIG. 2. In particular FIG. 3 shows a computer implemented method for managing incoming order allocation in an electronic trading system, the electronic trading system comprising a processor which implements a match engine and electronic market for an associated financial instrument by being operative to attempt to match an incoming order to buy or sell the associated financial instrument with at least one other previously received but unsatisfied order for a transaction counter thereto stored in an order book database coupled with the processor, to at least partially satisfy one or both of the incoming order or the at least one other previously received order, and, subsequent thereto, store data indicative of any unsatisfied remainder of the incoming order or the at least one other order in the order book database for a subsequent attempt to match against a later received incoming order. The operation includes: receiving, by the processor from a market participant, an incoming order to buy or sell the associated financial instrument, the order further comprising data identifying an entity to which the order is associated (Block 302); identifying, by the processor, a subset of the previously received but unsatisfied orders stored in the order book database which are counter to the incoming order, if there are any (Block 304); and attempting, by the processor, to match the incoming order only with those of the identified subset of the previously received but unsatisfied orders, if any, which are not associated with the entity (Block 306); and wherein if the incoming order is fully satisfied, retaining (or otherwise reinserting), by the processor, those orders of the identified subset of the previously received but unsatisfied orders in the order book database, if any, that are associated with the entity for subsequent attempts to match with later received incoming orders (Block 308); and wherein if the incoming order is not fully satisfied, taking, by the processor, an action in accordance with instructions included in the incoming order and/or those orders of the identified subset of the previously received but unsatisfied orders in the order book database that are associated with the entity (Block 310).

In one embodiment, wherein the incoming order is characterized by a price, the identifying may further include identifying, by the processor, the subset of the previously received but unsatisfied orders stored in the order book characterized by a price that is identical and/or better than the price of the incoming order.

In one embodiment, wherein the incoming order and each of the identified subset of previously received but unsatisfied orders not associated with the entity are characterized by an order quantity, the attempting may further include allocating, by the processor, the order quantity of the incoming order to one or more of the identified subset of previously received but unsatisfied orders not associated with the entity based on the order quantities thereof (Block 312). In one embodiment, the allocating may include allocating according to a FIFO algorithm, a pro rata algorithm, or a combination thereof. It will be appreciated that other allocation methods/algorithms, such as those mentioned above, may be used.

In one embodiment, the attempting may further include determining, by the processor, that a previously received but unsatisfied order of the identified subset of previously received but unsatisfied orders is not associated with the entity based on a comparison of an identifier included in the previously received but unsatisfied order and an identifier included in the incoming order.

In one embodiment, the action may include canceling any unsatisfied remainder of the incoming order, canceling those orders of the identified subset of the previously received but unsatisfied orders in the order book database that are associated with the entity, decrementing/reducing the quantity of the larger of the incoming or identified subset of the previously received but unsatisfied orders in the order book database that are associated with the entity by the quantity of the smaller thereof, or a combination thereof. Where the larger order is decremented by the quantity of one more resting orders for a lesser total quantity, the smaller resting orders may then be canceled (with the appropriate parties being notified, etc.). When the total quantity of all identified resting orders exceeds the incoming order quantity, the resting orders may be decremented in a similar manner to matching, e.g. the resting orders are decremented FIFO, pro rata or combinations thereof, with the appropriate parties being notified of the modifications.

In one embodiment, the retaining may further include retaining (or otherwise reinserting) those orders of the identified subset of the previously received but unsatisfied orders in the order book database that are associated with the entity at a priority level commensurate with a time at which they were received by the processor.

In one embodiment, the retaining may further include retaining (or otherwise reinserting) those orders of the identified subset of the previously received but unsatisfied orders in the order book database that are associated with the entity at a priority level commensurate with having just been received by the processor. It will be appreciated that the retaining may further include retaining those orders of the identified subset of the previously received but unsatisfied orders in the order book database that are associated with the entity at a different priority level, such as a midpoint, time-weighted or otherwise, between the priority level commensurate with a time at which they were received by the processor and the priority level commensurate with having just been received by the processor.

In one embodiment, if retaining, by the processor, those orders of the identified subset of the previously received but unsatisfied orders in the order book database that are associated with the entity for subsequent attempts to match with later received incoming orders would result in a crossed order book, the processor may take an action in accordance with instructions included in the incoming order and/or those orders of the identified subset of the previously received but unsatisfied orders in the order book database that are associated with the entity.

The operation of the system 200 may be further understood by way of the following examples.

### Example 1

### ‘Held’ Orders Retain their Original Priority

For an aggressing order with Self-match ID (SMID) of 123 for a quantity of 100 and a price of 9525:

| Bid SMID | Price | Qty | TOP |
|---|---|---|---|
| 123 | 9525 | 15 | Y |
| 987 | 9525 | 250 | N |
| 852 | 9525 | 500 | N |
| 693 | 9525 | 500 | N |
| 123 | 9525 | 250 | N |

When the order arrives both the TOP order and the 5th order in the book are placed into a “Hold” state and not allowed to participate in the match. The arriving order is matched in its entirety with resting orders still on the book.

In a pro-rata allocation the resulting book after the match where the 250 lot order received 20 lots and each of the 500 lot orders received 40 lots.

| SMID | Price | Qty | TOP |
|---|---|---|---|
| 123 | 9525 | 15 | Y |
| 987 | 9525 | 230 | N |
| 852 | 9525 | 460 | N |
| 693 | 9525 | 460 | N |
| 123 | 9525 | 250 | N |

### Example 2

### ‘Held’ Orders Lose their Original Priority

For an aggressing order with Self-match ID (SMID) of 123 for a quantity of 100 and a price of 9525:

| SMID | Price | Qty | TOP |
|---|---|---|---|
| 123 | 9525 | 15 | Y |
| 987 | 9525 | 250 | N |
| 852 | 9525 | 500 | N |
| 693 | 9525 | 500 | N |
| 123 | 9525 | 250 | N |

When the order arrives both the TOP order and the 5th order in the book are placed into a “Hold” state and not allowed to participate in the match. The arriving order is matched in its entirety with resting orders still on the book.

In a pro-rata allocation the resulting book after the match where the 250 lot order received 20 lots and each of the 500 lot orders received 40 lots.

| SMID | Price | Qty | TOP |
|---|---|---|---|
| 987 | 9525 | 230 | N |
| 852 | 9525 | 460 | N |
| 693 | 9525 | 460 | N |
| 123 | 9525 | 15 | N |
| 123 | 9525 | 250 | N |

### Example 3

For an aggressing order with Self-match ID (SMID) of 123 for a quantity of 1500 and a price of 9525:

| SMID | Price | Qty | TOP |
|---|---|---|---|
| 123 | 9525 | 15 | Y |
| 987 | 9525 | 250 | N |
| 852 | 9525 | 500 | N |
| 693 | 9525 | 500 | N |
| 123 | 9525 | 250 | N |

When the order arrives both the TOP order and the 5th order in the book are placed into a “Hold” state and not allowed to participate in the match. The arriving order is matched with the 1250 lots on the book at the best price. The unmatched quantity will then be validated against the SMID parameter to determine which side of the market is removed.

If the setting is to remove the arriving order the resulting book would be:

| SMID | Price | Qty | TOP |
|---|---|---|---|
| 123 | 9525 | 15 | Y |
| 123 | 9525 | 250 | N |

If the setting was to remove the resting order(s) the resulting book would be:

| Bid | Bid | Bid | | | Offer | Offer | Offer |
|---|---|---|---|---|---|---|---|
| SMID | Price | Qty | TOP | TOP | Qty | Price | SMID |
| | | | | Y | 250 | 9525 | 123 |

### Example 4

### Trade Through

For an aggressing order with Self-match ID (SMID) of 123 for a quantity of 1500 and a price of 9524:

| SMID | Price | Qty | TOP |
|---|---|---|---|
| 123 | 9525 | 15 | Y |
| 987 | 9525 | 250 | N |
| 852 | 9525 | 500 | N |
| 693 | 9525 | 500 | N |
| 123 | 9525 | 250 | N |
| 753 | 9524 | 500 | N |

When the order arrives both the TOP order and the 5th order in the book are placed into a “Hold” state and not allowed to participate in the match. The arriving order is matched with the 1250 lots on the book at the best price. The unmatched quantity of 250 contracts will then be validated against the SMID parameter to determine which side of the market is removed.

If the setting is to remove the arriving order, the remaining quantity of 250 from the arriving order would be eliminated due to self-match protections. The resulting book would be:

| SMID | Price | Qty | TOP |
|---|---|---|---|
| 123 | 9525 | 15 | Y |
| 123 | 9525 | 250 | N |

If the setting was to remove the resting order(s), the arriving order would match its balance of 250 with the resting order at 9524. The resulting book would be:

| SMID | Price | Qty | TOP |
|---|---|---|---|
| 753 | 9524 | 250 | N |

### Example 5

### With Iceberg Order Included in Book

For an aggressing order with Self-match ID (SMID) of 123 for a quantity of 1100 and price of 9525:

| SMID | Price | Qty | TOP |
|---|---|---|---|
| 123 | 9525 | 15 | Y |
| 987 | 9525 | 150 | N |
| 852 | 9525 | 500 (100 displayed) | N |
| 693 | 9525 | 500 | N |
| 123 | 9525 | 250 | N |

When the aggressing order arrives, the orders with the same SMID (top order for 15 and 250 lot order) will be placed into a “Hold” state. The arriving order has more quantity than the current displayed quantity of 750 contracts and will sweep the book filling the 150, 100 and 500 lots displayed. The display will be refreshed for the “iceberg” order and filled for 100 3 additional times as well as a fill for 50 of the final 100. The resulting book would be displayed as:

| SMID | Price | Qty | TOP |
|---|---|---|---|
| 123 | 9525 | 15 | Y |
| 123 | 9525 | 250 | N |
| 852 | 9525 | 50 | N |

The refreshed quantity order will be at the lowest priority based on time.

One skilled in the art will appreciate that one or more modules or logic described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an exchange 100 for financial instruments.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method of matching a first order received from a first trading entity with a second order received from a second trading entity, the method comprising:
establishing, by a processor, that the first order is at least partially counter to the second order;
identifying, by the processor, that the first trading entity is not permitted to transact with the second trading entity based on a relationship there between; and
preventing, by the processor, the first and second orders from matching with each other when the first order is at least partially counter to the second order and the first trading entity is identified as being related to the second trading entity and allowing the first order to be matched to other orders.

2. The computer implemented method of claim 1 wherein the first order is an incoming order and the second order is a previously received but unsatisfied orders, and wherein the method further comprises:
making, by the processor subsequent to the allowing, the second order available to be matched with a subsequently received order.

3. The computer implemented method of claim 2 wherein the second order is made available to be matched at a same priority as other orders available to be matched as prior to the preventing.

4. The computer implemented method of claim 2 wherein the second order is made available to be matched at a lower priority as other orders available to be matched.

5. The computer implemented method of claim 1 further comprising:
determining, by the processor when the first order is not completely satisfied by the other orders, an action to taken with respect to the first and/or second orders.

6. The computer implemented method of claim 5 wherein the action comprises canceling any unsatisfied remainder of the first order, canceling the second order, decrementing a quantity of a larger of the first and second orders by a quantity of a smaller of the first and second orders, or a combination thereof.

7. A computer implemented method of managing incoming order allocation in an electronic trading system, the electronic trading system comprising a processor which implements a match engine and electronic market for an associated financial instrument by being operative to attempt to match an incoming order to buy or sell the associated financial instrument with at least one other previously received but unsatisfied order for a transaction counter thereto stored in an order book database coupled with the processor, to at least partially satisfy one or both of the incoming order or the at least one other previously received order, and, subsequent thereto, store data indicative of any unsatisfied remainder of the incoming order or the at least one other order in the order book database for a subsequent attempt to match against a later received incoming order, the method comprising:
receiving, by the processor from a market participant, an incoming order to buy or sell the associated financial instrument, the order further comprising data identifying an entity to which the order is associated;
identifying, by the processor, a subset of the previously received but unsatisfied orders stored in the order book database which are counter to the incoming order; and
attempting, by the processor, to match the incoming order only with those of the identified subset of the previously received but unsatisfied orders which are not associated with the entity; and
wherein if the incoming order is fully satisfied, retaining, by the processor, those orders of the identified subset of the previously received but unsatisfied orders in the order book database that are associated with the entity for subsequent attempts to match with later received incoming orders; and
wherein if the incoming order is not fully satisfied, taking, by the processor, an action in accordance with instructions included in the incoming order and/or those orders of the identified subset of the previously received but unsatisfied orders in the order book database that are associated with the entity.

8. The computer implemented method of claim 7 wherein the incoming order is characterized by a price, the identifying further comprising identifying, by the processor, the subset of the previously received but unsatisfied orders stored in the order book characterized by a price that is identical and/or better than the price of the incoming order.

9. The computer implemented method of claim 7 wherein the incoming order and each of the identified subset of previously received but unsatisfied orders not associated with the entity are characterized by an order quantity, the attempting further comprising allocating, by the processor, the order quantity of the incoming order to one or more of the identified subset of previously received but unsatisfied orders not associated with the entity based on the order quantities thereof.

10. The computer implemented method of claim 9 wherein the allocating comprises allocating according to a FIFO algorithm, a pro rata algorithm, or a combination thereof.

11. The computer implemented method of claim 7 wherein the attempting further comprises determining, by the processor, that a previously received but unsatisfied order of the identified subset of previously received but unsatisfied orders is not associated with the entity based on a comparison of an identifier included in the previously received but unsatisfied order and an identifier included in the incoming order.

12. The computer implemented method of claim 7 wherein the action comprises canceling any unsatisfied remainder of the incoming order, canceling those orders of the identified subset of the previously received but unsatisfied orders in the order book database that are associated with the entity, decrementing a quantity of a larger of the incoming order and those orders of the identified subset of the previously received but unsatisfied orders in the order book database that are associated with the entity by a quantity of a smaller thereof, or a combination thereof.

13. The computer implemented method of claim 7 wherein the retaining further comprises retaining those orders of the identified subset of the previously received but unsatisfied orders in the order book database that are associated with the entity at a priority level commensurate with a time at which they were received by the processor.

14. The computer implemented method of claim 7 wherein the retaining further comprises retaining those orders of the identified subset of the previously received but unsatisfied orders in the order book database that are associated with the entity at a priority level commensurate with having just been received by the processor.

15. The computer implemented method of claim 7 wherein if retaining, by the processor, those orders of the identified subset of the previously received but unsatisfied orders in the order book database that are associated with the entity for subsequent attempts to match with later received incoming orders would result in a crossed order book, taking, by the processor, an action in accordance with instructions included in the incoming order and/or those orders of the identified subset of the previously received but unsatisfied orders in the order book database that are associated with the entity

16. A system for managing incoming order allocation in an electronic trading system, the electronic trading system comprising means for implementing a match engine and electronic market for an associated financial instrument by being operative to attempt to match an incoming order to buy or sell the associated financial instrument with at least one other previously received but unsatisfied order for a transaction counter thereto stored in an order book database coupled with the processor, to at least partially satisfy one or both of the incoming order or the at least one other previously received order, and, subsequent thereto, store data indicative of any unsatisfied remainder of the incoming order or the at least one other order in the order book database for a subsequent attempt to match against a later received incoming order, the system comprising:
means for receiving, from a market participant, an incoming order to buy or sell the associated financial instrument, the order further comprising data identifying an entity to which the order is associated;
means for identifying a subset of the previously received but unsatisfied orders stored in the order book database which are counter to the incoming order; and
means for attempting to match the incoming order only with those of the identified subset of the previously received but unsatisfied orders which are not associated with the entity; and
means for, when the incoming order is fully satisfied, retaining those orders of the identified subset of the previously received but unsatisfied orders in the order book database that are associated with the entity for subsequent attempts to match with later received incoming orders; and
means for, when the incoming order is not fully satisfied, taking an action in accordance with instructions included in the incoming order and/or those orders of the identified subset of the previously received but unsatisfied orders in the order book database that are associated with the entity.

17. A system for managing incoming order allocation in an electronic trading system, the electronic trading system comprising a processor and non-transitory memory coupled therewith which implements a match engine and electronic market for an associated financial instrument by being operative to attempt to match an incoming order to buy or sell the associated financial instrument with at least one other previously received but unsatisfied order for a transaction counter thereto stored in an order book database coupled with the processor, to at least partially satisfy one or both of the incoming order or the at least one other previously received order, and, subsequent thereto, store data indicative of any unsatisfied remainder of the incoming order or the at least one other order in the order book database for a subsequent attempt to match against a later received incoming order, the system comprising:
first logic stored the memory and executable by the processor to cause the processor to receive, from a market participant, an incoming order to buy or sell the associated financial instrument, the order further comprising data identifying an entity to which the order is associated;
second logic stored the memory and executable by the processor to cause the processor to identify a subset of the previously received but unsatisfied orders stored in the order book database which are counter to the incoming order; and
third logic stored the memory and executable by the processor to cause the processor to attempt to match the incoming order only with those of the identified subset of the previously received but unsatisfied orders which are not associated with the entity; and
fourth logic stored the memory and executable by the processor to cause the processor to, when the incoming order is fully satisfied, retain those orders of the identified subset of the previously received but unsatisfied orders in the order book database that are associated with the entity for subsequent attempts to match with later received incoming orders; and
fifth logic stored the memory and executable by the processor to cause the processor to, when the incoming order is not fully satisfied, take an action in accordance with instructions included in the incoming order and/or those orders of the identified subset of the previously received but unsatisfied orders in the order book database that are associated with the entity.

18. A system for managing incoming order allocation in an electronic trading system, the electronic trading system comprising a match engine processor and non-transitory memory coupled therewith which implements a match engine and electronic market for an associated financial instrument by being operative to attempt to match an incoming order to buy or sell the associated financial instrument with at least one other previously received but unsatisfied order for a transaction counter thereto stored in an order book database coupled with the processor, to at least partially satisfy one or both of the incoming order or the at least one other previously received order, and, subsequent thereto, store data indicative of any unsatisfied remainder of the incoming order or the at least one other order in the order book database for a subsequent attempt to match against a later received incoming order, the system comprising:
an order processor coupled with the match engine processor and operative to receive, from a market participant, an incoming order to buy or sell the associated financial instrument, the order further comprising data identifying an entity to which the order is associated;
an identity identifier coupled with the order processor and operative to identify a subset of the previously received but unsatisfied orders stored in the order book database which are counter to the incoming order; and
a transaction processor coupled with the order processor and identity identifier and operative to attempt to match the incoming order only with those of the identified subset of the previously received but unsatisfied orders which are not associated with the entity; and
wherein the transaction processor is further operative to, when the incoming order is fully satisfied, retain those orders of the identified subset of the previously received but unsatisfied orders in the order book database that are associated with the entity for subsequent attempts to match with later received incoming orders; and
wherein the transaction processor is further operative to, when the incoming order is not fully satisfied, take an action in accordance with instructions included in the incoming order and/or those orders of the identified subset of the previously received but unsatisfied orders in the order book database that are associated with the entity.

19. The system of claim 18 wherein the incoming order is characterized by a price, the identity identifier being further operative to identify the subset of the previously received but unsatisfied orders stored in the order book characterized by a price that is identical and/or better than the price of the incoming order.

20. The system of claim 18 further comprising an allocation processor coupled with the transaction processor and operative to, wherein the incoming order and each of the identified subset of previously received but unsatisfied orders not associated with the entity are characterized by an order quantity, allocate, by the processor, the order quantity of the incoming order to one or more of the identified subset of previously received but unsatisfied orders not associated with the entity based on the order quantities thereof.

21. The system of claim 20 wherein the allocation processor is further operative to allocate according to a FIFO algorithm, a pro rata algorithm, or a combination thereof.

22. The system of claim 18 wherein the transaction processor is further operative to determine that a previously received but unsatisfied order of the identified subset of previously received but unsatisfied orders is not associated with the entity based on a comparison of an identifier included in the previously received but unsatisfied order and an identifier included in the incoming order.

23. The system of claim 18 wherein the action comprises canceling any unsatisfied remainder of the incoming order, canceling those orders of the identified subset of the previously received but unsatisfied orders in the order book database that are associated with the entity, decrementing/reducing the quantity of the larger of the incoming order or those orders of the identified subset of the previously received but unsatisfied orders in the order book database that are associated with the entity by the quantity of the smaller thereof, or a combination thereof.

24. The system of claim 18 wherein the transaction processor is further operative to retain those orders of the identified subset of the previously received but unsatisfied orders in the order book database that are associated with the entity at a priority level commensurate with a time at which they were received by the processor.

25. The system of claim 18 wherein the transaction processor is further operative to retain those orders of the identified subset of the previously received but unsatisfied orders in the order book database that are associated with the entity at a priority level commensurate with having just been received by the processor.

26. The system of claim 18 wherein if retention, by the transaction processor, those orders of the identified subset of the previously received but unsatisfied orders in the order book database that are associated with the entity for subsequent attempts to match with later received incoming orders would result in a crossed order book, the transaction processor being further operative to take an action in accordance with instructions included in the incoming order and/or those orders of the identified subset of the previously received but unsatisfied orders in the order book database that are associated with the entity
